(19) United States
(12) Patent Application Publication
(10) Pub. No.: US 2026/0270936 A1
(43) Pub. Date: Sep. 10, 2026

(54) METHODS AND APPARATUSES FOR POSITIONING OPERATION

(71) Applicant: LENOVO (BEIJING) LIMITED, Beijing (CN)

(72) Inventors: Min XU, Beijing (CN); Jing HAN, Beijing (CN); Lianhai WU, Beijing (CN); Jie HU, Beijing (CN); Ran YUE, Beijing (CN)

(21) Appl. No.: 19/165,752

(22) PCT Filed: Mar. 17, 2023
(86) PCT No.: PCT/CN2023/082330

§ 371 Date: Sep. 16, 2025

(51) Int. Cl. H04W 64/00

(52) U.S. Cl. CPC H04W 64/00

(57) ABSTRACT

The present application relates to methods and apparatuses for a positioning operation. An embodiment of the present disclosure provides a user equipment (UE), which includes: a transceiver; and a processor coupled with the transceiver and configured to: transmit, via the transceiver, to a positioning server, assistance information for a positioning operation before an end of the positioning operation, wherein the assistance information includes at least one of available time information for the positioning operation or ephemeris information of a transmission and reception point (TRP); and receive, via the transceiver, from a base station (BS), a configuration for the positioning operation.

### TECHNICAL FIELD

The present disclosure relates to wireless communication, and particularly relates to methods and apparatuses for a positioning operation.

### BACKGROUND OF THE INVENTION

A non-terrestrial network (NTN) refers to a network, or segment of networks using radio frequency (RF) resources on board a satellite or a high altitude platform station (HAPS). The satellite in NTN may be a geostationary Earth orbiting (GEO) satellite with fixed location to the Earth, or a low Earth orbiting (LEO) satellite orbiting around the Earth. In some scenarios, the satellite in NTN may also include microsatellite platforms (a.k.a. Cube satellites) with limited size and power and low-density satellite constellations, which have restricted link budget and discontinuous coverage where the UE can remain long periods of time without being able to detect a satellite cell.

Compared with a terrestrial network (TN), the coverage of an NTN may be much wider, and the NTN services may be offered through radio access technologies whose coverage may extend well beyond the political borders of countries wherein regulations of communication services may be different.

When dealing with communication services over borders, an essential question is that which regulations should be applied. The network operator may be mandated to cross check the UE location in order to fulfil the regulatory requirements regarding UE location.

However, there are several issues for performing the positioning operation in the NTN, or other similar networks with a limited number of transmission and reception points (TRP). Accordingly, it is advantageous to provide solutions for the positioning operation.

### SUMMARY

An embodiment of the present disclosure provides a user equipment (UE), which includes: a transceiver; and a processor coupled with the transceiver and configured to: transmit, via the transceiver, to a positioning server, assistance information for a positioning operation before an end of the positioning operation, wherein the assistance information includes at least one of available time information for the positioning operation or ephemeris information of a TRP; and receive, via the transceiver, from a base station (BS), a configuration for the positioning operation.

In some embodiments, the available time information for the positioning operation includes at least one of the following: a feeder link switch time value of a cell or the TRP obtained from the BS; a stop serving time value of the cell or the TRP obtained from the BS; a UE-specific stop serving time value of the cell or the TRP determined by the UE; a remaining validity duration of ephemeris information of the TRP determined by the UE; or a remaining validity duration of a global navigation satellite system (GNSS) position determined by the UE.

In some embodiments, the ephemeris information of the TRP includes at least one of the following: an epoch time value of the ephemeris information; a validity duration of the ephemeris information; an identifier of the ephemeris information; or a format of the ephemeris information.

In some embodiments, the configuration for the positioning operation indicates at least two measurement windows or at least two reference signal resources, wherein a time interval is included between two measurement windows of the at least two measurement windows or two reference signal resources of the at least two reference signal resources; or wherein a measurement window of the at least two measurement windows or a reference signal resource of the at least two reference signal resources is associated with at least one of a starting time value or an end time value.

In some embodiments, the UE may re-acquire ephemeris information in response to one of the following: an end of a remaining validity duration of the ephemeris information of a serving cell of the UE being earlier than a last measurement window or a last reference signal resource for the positioning operation; the end of the remaining validity duration of the ephemeris information of the serving cell of the UE being earlier than a measurement window or a reference signal resource for the positioning operation; or a time interval between two measurement windows or two reference signal resources for the positioning operation being equal to or longer than a time duration for re-acquiring the ephemeris information.

In some embodiments, the UE may re-acquire a GNSS position in response to one of the following: an end of a remaining validity duration of the GNSS position being earlier than a last measurement window or a last reference signal resource for the positioning operation; the end of the remaining validity duration of the GNSS position being earlier than a measurement window or a reference signal resource for the positioning operation; or a time interval between two measurement windows or two reference signal resources for the positioning operation being equal to or longer than a time duration for re-acquiring the GNSS position.

In some embodiments, the two measurement windows are two neighboring measurement windows, any two measurement windows, or two specific measurement windows; and wherein the two reference signal resources are two neighboring reference signal resources in the time domain, any two reference signal resources, or two specific reference signal resources.

Another embodiment of the present disclosure provides a BS, which includes: a transceiver; and a processor coupled with the transceiver and configured to: transmit, via the transceiver, to a positioning server, assistance information for a positioning operation before an end of the positioning operation, wherein the assistance information includes at least one of available time information for the positioning operation or ephemeris information of a TRP; and receive, via the transceiver, from the positioning server, first information for the positioning operation.

In some embodiments, the BS may transmit, via the transceiver, to a UE, a configuration for the positioning operation based on the first information for the positioning operation.

In some embodiments, the first information for the positioning operation indicates one of the following: a first time interval for UE positioning measurement; or a second time interval for TRP positioning measurement.

In some embodiments, the configuration for the positioning operation indicates at least two measurement windows or at least two reference signal resources, in the case that the first time interval for UE positioning measurement is indicated, a time interval with a length equal to or longer than a length of the first time interval is included between two measurement windows of the at least two measurement windows or two reference signal resources of the at least two reference signal resources; or in the case that the second time interval for TRP positioning measurement is indicated, a time interval with a length equal to or longer than a sum of a length of the second time interval plus a maximum round trip time (RTT) value is included between two measurement windows of the at least two measurement windows, or between two reference signal resources of the at least two reference signal resources, wherein the RTT value is a round trip time value between the UE and the TRP associated with the BS, or between the UE and the BS; wherein the two measurement windows are two neighboring measurement windows, any two measurement windows, or two specific measurement windows; and wherein the two reference signal resources are two neighboring reference signal resources in the time domain, any two reference signal resources, or two specific reference signal resources.

In some embodiments, the first information for the positioning operation indicates at least two reference time values, and in the case a reference time value of the at least two reference time values is a starting time value for UE measurement, the configuration indicates a measurement window or a reference signal resource with a starting time value later than or equal to the reference time value; in the case a reference time value of the at least two reference time values is an end time value for UE measurement, the configuration indicates a measurement window or a reference signal resource with an end time value earlier than or equal to the reference time value; in the case a reference time value of the at least two reference time values is a starting time value for TRP measurement, the configuration indicates a measurement window or a reference signal resource with a starting time value later than or equal to the reference time value plus a half of an RTT value; or in the case a reference time value of the at least two reference time values is an end time value for TRP measurement, the configuration indicates a measurement window or a reference signal resource with an end time value earlier than or equal to the reference time value minus the half of the RTT value; wherein the RTT value is a round trip time value between the UE and the TRP associated with the BS, or between the UE and the BS.

In some embodiments, the first information for the positioning operation indicates an accuracy requirement for the positioning operation.

In some embodiments, the available time information for the positioning operation includes at least one of the following: a feeder link switch time value of a cell or a TRP; a stop serving time value of the cell or the TRP; a UE-specific stop serving time value of the cell or the TRP obtained from the UE; a remaining validity duration of ephemeris information of the TRP obtained from the UE; or a remaining validity duration of a GNSS position obtained from the UE.

In some embodiments, the ephemeris information of the TRP includes at least one of the following: an epoch time value of the ephemeris information; a validity duration of the ephemeris information; an identifier of the ephemeris information; or a format of the ephemeris information.

Yet another embodiment of the present disclosure provides a positioning server, which includes: a transceiver; and a processor coupled with the transceiver and configured to: receive, via the transceiver, from at least one of a BS or a UE, assistance information for a positioning operation before an end of the positioning operation; or transmit, via the transceiver, to the BS, first information for the positioning operation; and determine to initiate the positioning operation, wherein the assistance information includes at least one of available time information for the positioning operation or ephemeris information of a TRP.

In some embodiments, the BS may determine to initiate the positioning operation based on the assistance information.

In some embodiments, the available time information for the positioning operation from the UE includes at least one of the following: a feeder link switch time value of a serving cell or the TRP obtained from the BS; a stop serving time value of the serving cell or the TRP obtained from the BS; a UE-specific stop serving time value of the serving cell or the TRP determined by the UE; a remaining validity duration of ephemeris information of the TRP determined by the UE; or a remaining validity duration of a GNSS position determined by the UE.

In some embodiments, the available time information for the positioning operation from the BS includes at least one of the following: a feeder link switch time value of a serving cell or a TRP; a stop serving time value of the serving cell or the TRP; a UE-specific stop serving time value of the serving cell or the TRP obtained from the UE; a remaining validity duration of ephemeris information of the TRP obtained from the UE; or a remaining validity duration of a GNSS position obtained from the UE.

In some embodiments, the ephemeris information of the TRP includes at least one of the following: a feeder link switch time value of a serving cell or a TRP; a stop serving time value of the serving cell or the TRP; an epoch time value of the ephemeris information; a validity duration of the ephemeris information; an identifier of the ephemeris information; or a format of the ephemeris information.

In some embodiments, the positioning server may: determine a position of the TRP at a specific time value based on the ephemeris information of the TRP.

In some embodiments, the positioning server may: determine the first information based on the assistance information.

In some embodiments, the first information for the positioning operation indicates one of the following: a first time interval for UE positioning measurement; or a second time interval for TRP positioning measurement; at least two reference time values, wherein a reference time value of the at least two reference time values indicates one of the following: a starting time value for UE measurement, an end time value for UE measurement, a starting time value for TRP measurement, or an end time value for TRP measurement; or an accuracy requirement for the positioning operation.

In some embodiments, the positioning server may: indicate the UE to re-acquire the ephemeris information of the TRP or the GNSS position based on the assistance information before the end of the positioning operation.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A illustrates a schematic diagram of a wireless communication system according to some embodiments of the present disclosure.

FIG. 1B illustrates another schematic diagram of a wireless communication system according to some embodiments of the present disclosure.

FIG. 2A illustrates a schematic diagram of a positioning operation according to some embodiments of the present disclosure.

FIG. 2B illustrates a schematic diagram of a positioning operation according to some embodiments of the present disclosure.

FIG. 3 illustrates a schematic diagram of a positioning operation according to some embodiments of the present disclosure.

FIGS. 4A and 4B illustrate two measurement windows for a positioning operation configured based on the indicated time interval according to some embodiments of the present disclosure.

FIGS. 5A-5D illustrate two measurement windows for a positioning operation configured based on the indicated reference time values for UE measurement(s) according to some embodiments of the present disclosure.

FIGS. 6A-6D illustrate two measurement windows for a positioning operation configured based on the indicated reference time values for TRP measurement(s) according to some embodiments of the present disclosure.

FIG. 7 illustrates a method performed by a UE for a positioning operation according to some embodiments of the present disclosure.

FIG. 8 illustrates a method performed by a BS for a positioning operation according to some embodiments of the present disclosure.

FIG. 9 illustrates a method performed by a positioning server for a positioning operation according to some embodiments of the present disclosure.

FIG. 10 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3^{rd} generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

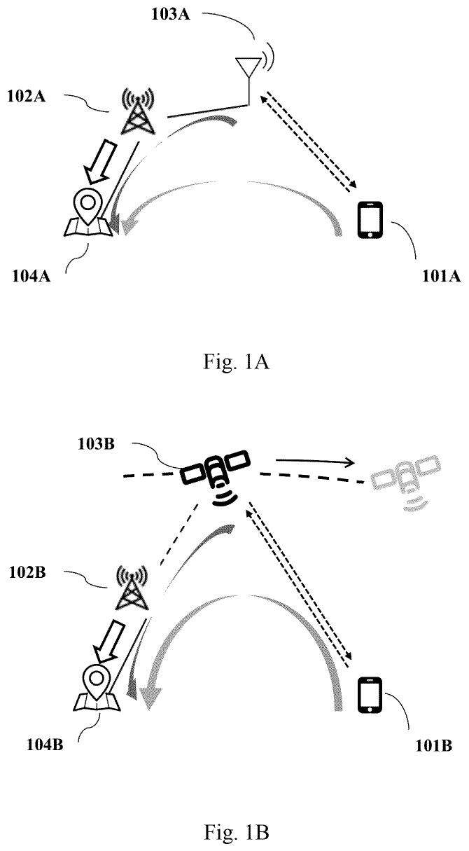

FIG. 1A illustrates a schematic diagram of a wireless communication system according to some embodiments of the present disclosure.

As shown in FIG. 1A, the network includes a UE 101A, a BS 102A, a TRP 103A, and a positioning server 104A. Although only one UE 101A, one BS 102A, one TRP 103A, and one positioning server 104A are depicted in FIG. 1A, it is contemplated that any number of UEs, BSs, TRPs, or positioning servers may be included in the wireless communication system.

The UE 101A may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, UE 101A may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 101A may include wearable devices, such as smart watches, fitness bands, optical head-mounted displays, or the like. Moreover, UE 101A may be referred to as subscriber units, mobiles, mobile stations, users, terminals, mobile terminals, wireless terminals, fixed terminals, subscriber stations, user terminals, a device, or by other terminology used in the art.

BS 102A may be distributed over a geographic region. In certain embodiments of the present disclosure, BS 102A may also be referred to as an access point, an access terminal, a base, a base unit, a macro cell, a node-B, an evolved node B (eNB), a gNB, a home node-B, a relay node, or a device, or described using other terminology used in the art. The BS 102A is generally a part of a radio access network that may include one or more controllers communicably coupled to one or more corresponding BS 102A. BS 102A may communicate with UE 101A via Uu interface. For example, BS 102A may transmit downlink (DL) communication signals to UE 101A, and may receive uplink (UL) communication signals from UE 101A.

TRP 103A may be antenna units, which may be fixed on the Earth, and may always be available. TRP 103A may belong to BS 102A, and BS 102A may only need to provide the location of TRP 103A, for example, the location in 3D coordinates once to the positioning server 104A.

TRP 103A may transmit DL positioning signals for measurements to the UE, and may receive UL positioning signals for measurements from the UE. The measurement results at TRP 103A may be transmitted to the positioning server 104A. The measurement results at UE 101A may also be transmitted to the positioning server 104A. Based on these measurement results from one or more TRPs and the UE, as well as the location of the one or more TRPs, the position of the UE may be determined by the positioning server 104A.

Positioning server 104A may be a location management function (LMF) entity in 5G network, which may be an entity in the core network that may determine the geographical location information of UE by measuring wireless signals.

FIG. 1B illustrates another schematic diagram of a wireless communication system according to some embodiments of the present disclosure.

As shown in FIG. 1B, the network includes a UE 101B, a BS 102B, a TRP 103B, and a positioning server 104B. Although only one UE 101B, one BS 102B, one TRP 103B, and one positioning server 104B are depicted in FIG. 1B, it is contemplated that any number of UEs, BSs, TRPs, or positioning servers may be included in the wireless communication system.

UE 101B may be similar with UE 101A. In addition, UE 101B may communicate directly with TRP 103B via a service link. TRP 103B may be a satellite, such as a LEO satellite, an MEO satellite, a GEO satellite, or a highly elliptical orbiting (HEO) satellite.

Referring still to FIG. 1B, TRP 103B provides a geographic cell for serving UE 101B located in the geographic cell. In FIG. 1B, UE 101B may be a normal mobile terminal 101, which can wirelessly communicate with TRP 103B via a communications link, such as service link or radio link in accordance with a NR access technology (e.g., a NR-Uu interface). TRP 103B may also communicate with a gateway or earth station via a communication link, which may be a feeder link or radio link in accordance with NR access technologies or other technologies. In accordance with various embodiments, TRP 103B may be implemented with either a transparent or a regenerative payload. When the satellite carries a “transparent” payload, it performs only radio frequency filtering, frequency conversion and/or amplification of signals on board. Hence, the waveform signal repeated by the payload is un-changed. When a satellite carries a regenerative payload, in addition to performing radio frequency filtering, frequency conversion and amplification, it performs other signal processing functions such as demodulation/decoding, switching and/or routing, coding/decoding and modulation/demodulation on board as well. In other words, for a satellite with a regenerative payload (i.e., all or part of base station functions (e.g., a gNB, eNB, etc.) are implemented on board. Hereinafter in the present disclosure, TRP 103B may also be referred to as a RAN node, which may include a satellite with a regenerative payload or a satellite with a regenerative payload. The RAN node may act as an access node, while in some other embodiments of the present disclosure, TRP 103B may also act as a BS.

The wireless communication system described in FIGS. 1A and 1B may be compliant with any type of network that is capable of sending and receiving wireless communication signals. For example, the wireless communication system is compliant with a wireless communication network, a cellular telephone network, a time division multiple access (TDMA)-based network, a code division multiple access (CDMA)-based network, an orthogonal frequency division multiple access (OFDMA)-based network, a LTE network, a 3GPP-based network, 3GPP 5G network, a satellite communications network, a high altitude platform network, and/or other communications networks.

In one implementation, the wireless communication system is compliant with the NR of the 3GPP protocol, wherein BS 102B transmits using an OFDM modulation scheme on the DL and UE 101B transmits on the UL using a single-carrier frequency division multiple access (SC-FDMA) scheme or OFDM scheme. More generally, however, the wireless communication system may implement some other open or proprietary communication protocol, for example, WiMAX, among other protocols.

3GPP Rel-17 specifications have provided basic support of NTN features, and in Rel-18 further enhancements are to be studied. The UE location verification by the network is considered as one of the major objectives for Rel-18 NTN enhancements, and is studied in RAN study item “Study on requirements and use cases for network verified UE location for NTN in NR”.

In the NTN, due to the purpose of verification, UE-based positioning methods are precluded, and only network-based positioning methods (e.g., observed time difference of arrival (OTDOA), (NR) enhanced cell-ID (E-CID), Multi-RTT, uplink time difference of arrival (UL-TDOA) and Uplink angle of arrival (UL-AOA), etc.) are considered in Rel-18 NTN for UE location verification. For the network-based positioning methods, the positioning server, e.g., LMF entity in 5G network, may use the reported measurement results from the UE, the BS, or both, and the and the location(s) of the TRP(s)) to calculate the UE location. The measurement results may include angle(s), identity (ies), time value(s), and signal strength(es) for the TRP(s).

However, there are several issues for performing the network-positioning operation in the NTN, or other similar networks with a limited number of TRP, for example, one single TRP, and the issues are described as follows.

### Issue #1

In the TN, there may be multiple available TRPs for network-based positioning operation, the BS may configure a positioning measurement window (or a measurement gap, or one or more measurement resources) to obtain the measurements for multiple TRPs at one time.

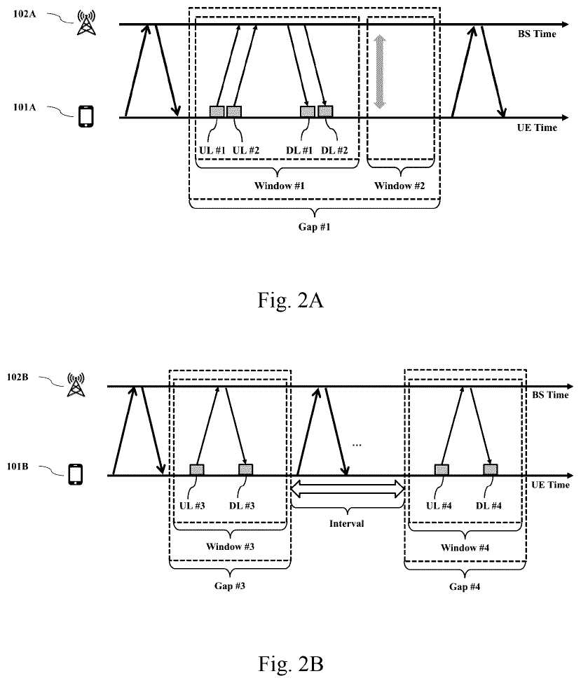

FIG. 2A illustrates a schematic diagram of a positioning operation according to some embodiments of the present disclosure.

Before performing the positioning operation, the UE, e.g. UE 101A and the BS, e.g. BS 102A, may perform user data transmission and reception.

A measurement gap, e.g. gap #1 as shown in FIG. 2A, may be configured, which may be a common time duration during which UE 101A may use for positioning signals transmission or reception, or for other purposes. For example, there are two windows in the measurement gap, e.g. window #1 and window #2, window #1 may be the positioning measurement window, during which the UE may use one or more UL positioning resources, e.g. UL #1 and UL #2, to perform the transmission of the positioning signals, such as the UL sounding reference signal (SRS). The UE may use one or more DL positioning resources, e.g. DL #1 and DL #2, to perform the reception of the positioning signals, such as the DL positioning reference signal (PRS). The positioning measurement window may be a dedicated time duration during which the UE may only perform the transmission or reception of the positioning signals; and the positioning resource may be a dedicated time-frequency resource for positioning signals transmission or reception.

Window #2 may be another measurement window, during which the UE may perform the transmission and reception of other signals.

After the measurement gap, the UE and the BS may continue performing user data transmission and reception

In NTN, the number of TRPs, e.g. satellites, may be much less compared with the TRPs, e.g. antenna units in the TN. From the perspective of satellite availability and complexity of implementation, the network-based positioning measurements may use a single TRP. For a positioning operation with a single TRP, the positioning measurement may need to be performed at least twice at different time points, and the time interval between two measurements may need to be large enough to fulfill a certain accuracy requirement.

FIG. 2B depicts a schematic diagram of a positioning operation according to some embodiments of the present disclosure.

Before performing the positioning operation, the UE, e.g. UE 101B and the BS, e.g. BS 102B, may perform user data transmission and reception.

Two measurement gap, e.g. gap #3 and gap #4 as shown in FIG. 2B, may be configured, which may be common time durations during which UE 101B may use for positioning signals transmission or reception, or for other purposes. Between measurement gap #3 and measurement gap #4, there is an interval, which may be long enough to fulfill the accuracy requirement.

A measurement window, e.g. window #3 may be configured in measurement gap #3, which may be the positioning measurement window, during which the UE may use one UL positioning resource, e.g. UL #3, to perform the transmission of the positioning signals, such as the UL SRS. The UE may use one DL positioning resource, e.g. DL #3, to perform the reception of the positioning signals, such as the DL PRS. A measurement window, e.g. window #4 may be configured in measurement gap #4, which may be the positioning measurement window, during which the UE may use one UL positioning resource, e.g. UL #4, to perform the transmission of the positioning signals, and the UE may use one DL positioning resource, e.g. DL #4, to perform the reception of the positioning signals.

In FIG. 2B, the positioning measurement may be performed twice, the duration of the entire positioning operation may be the length of the two measuring windows and the interval, which is longer than the positioning operation in FIG. 2A.

In some other cases, the positioning measurement may be performed with more times, such as three times, five times, etc. In this case, the entire positioning operation may be even longer.

Accordingly, the issue for the positioning operation with one TRP is that the duration of the positioning operation may be long. The issue also exists for the positioning operation which needs to be performed multiple times at different time points.

### Issue #2

In order to complete a network-based positioning operation for UE location verification in the NTN, a valid UE location result and valid ephemeris data may be needed at the UE, which may not be guaranteed.

In the TN, due to the short distance between UE and BS (e.g., less than 5 km), the network may detect the timing misalignment due to the round-trip propagation delay (e.g., less than 0.033 ms) and may indicate the UE to compensate in timing advance using a command, e.g. a timing advance command to guarantee uplink synchronization.

In the NTN, the distance between UE and satellite may be hundreds or thousands of kilometers (e.g., for a LEO satellite, a typical orbit may be at 600 km or 1200 km), which may lead to a larger round-trip propagation delay (e.g., the round-trip propagation delay may be 8 ms or 16 ms for a LEO satellite at 600 km or at 1200 km). The UE may calculate the timing advance based on the UE location as well as the satellite location, and pre-compensate the round-trip propagation delay for uplink synchronization. Therefore, the UE may need to ensure both a valid UE location result and valid satellite location information (e.g., valid ephemeris data of the satellite).

Currently, when the UE do not have a valid UE location or valid ephemeris data, the UE may need to enter an IDLE state and re-acquire UE location (e.g., via GNSS) or an ephemeris data (via system information).

The necessity of maintaining a valid UE location result and valid ephemeris data for uplink synchronization in NTN may lead to another availability issue in network-based positioning. That is, during the performance of a positioning operation, a valid UE location result and valid ephemeris data are needed at the UE.

For the ephemeris data, it is up to UE implementation to re-acquire before it expires. If the ephemeris data expires during a positioning measurement gap or window, the UE could be unable to re-acquire it timely and may enter the IDLE state due to UL synchronization lost and the positioning operation may be terminated.

For the GNSS position which requires long time of operation (seconds or tens of seconds), if it expires at any time during the positioning operation (in or between positioning measurement gaps or windows), UE may enter the IDLE state due to UL synchronization lost and the positioning operation may be terminated.

The issue could be more serious when the positioning operation is performed by a single TRP at different time points instead of multiple TRPs at one time since the former requires much longer time duration than the latter.

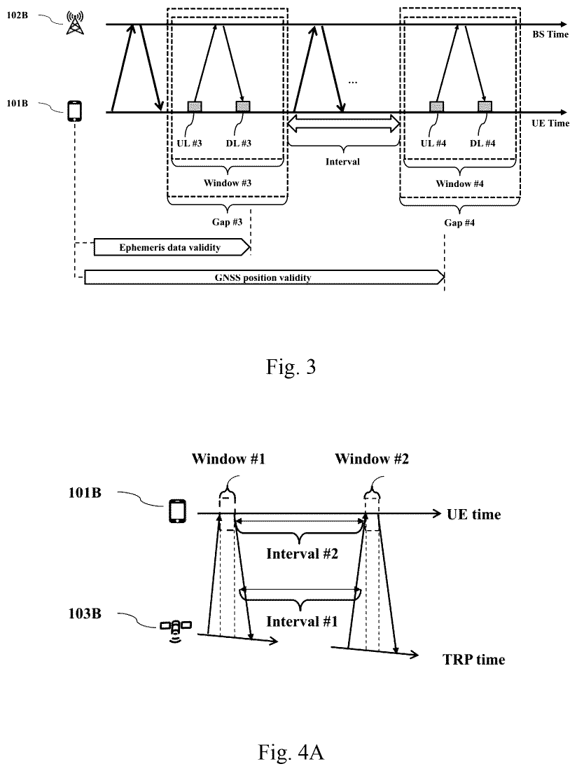

FIG. 3 illustrates a schematic diagram of a positioning operation according to some embodiments of the present disclosure.

The positioning operation in FIG. 3 is similar to that in FIG. 2B, and details are omitted here. In FIG. 3, the validity of ephemeris data may expire within the duration of gap #3, which may render the UE entering into an IDLE state to re-acquire the ephemeris data. The validity of GNSS position may expire within the duration of gap #4, which may also render the UE entering into an IDLE state to re-acquire the UE location. The UL synchronization is lost during the positioning operation.

### Issue #3

In the NTN, a TRP may be the serving satellite providing LTE or NR access for the UE. The satellite may travel on orbit around the Earth, accordingly, the position of the satellite may vary over time with limited available duration. For example in the worst case, a LEO satellite moves at a maximum speed of 7.9 km/s and its serving duration for a given location may only last several seconds. In the NTN, the satellite location is represented by ephemeris data and is broadcasted from the BS to the UE. However, the positioning server may not be aware of the location of the satellite (e.g. the TRP), which may decrease the accuracy of the positioning operation.

The present disclosure proposes some solutions for solving the above issues #1-#3.

### Solution 1

In this solution, the positioning server, e.g. the positioning server 104B, may provide information for the positioning operation, and based on the provided information for the positioning operation, the BS may configure at least two measurement windows (or at least two measurement gaps, or at least two reference signal resources, or the like). In some embodiments, the reference signal resource may include a UL positioning resource and a corresponding DL positioning resource. The BS may further generate a configuration for the positioning operation, which indicates the at least two measurement windows (or at least two measurement gaps, or at least two reference signal resources, or the like), transmit the configuration for the positioning operation to the UE. The configuration for the positioning operation may be transmitted via a new message, or via an existing message. The information for the positioning operation from the positioning server may be further described in following embodiments.

### Embodiment 1

The information for the positioning operation may indicate at least one time interval (or at least one time duration, at least one length of time duration, or the like). For an indicated time interval of the at least one indicated time interval, the BS may configure the UE with at least two measurement windows, or at least two reference signal resources with a time interval equal to or longer than the indicated time interval.

The indicated time interval may be:
The time interval between any two measurement windows, or any two measurement gaps, any two reference signal resources, any two UL positioning resources, any two DL positioning resources, any two positioning resources, or the like;
The time interval between two specific measurement windows, or two specific measurement gaps, two specific reference signal resources, two specific UL positioning resources, two specific DL positioning resources, two specific positioning resources, or the like; or
The time interval between any two neighboring measurement windows, or any two neighboring measurement gaps, any two neighboring reference signal resources, any two neighboring UL positioning resources, any two neighboring DL positioning resources, any two neighboring positioning resources, or the like.

In some embodiments, the indicated time interval may be for UE measurement(s), and the BS may configure the UE with at least two measurement windows (or at least two measurement gaps, or at least two reference signal resources, or the like) with a time interval equal to or longer than the indicated time interval.

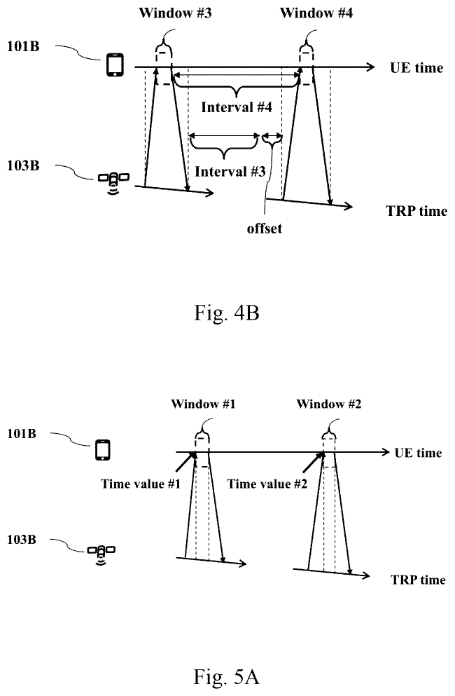

FIGS. 4A and 4B illustrate two measurement windows for a positioning operation configured based on the indicated time interval according to some embodiments of the present disclosure.

In FIG. 4A, the positioning server may indicate a time interval for UE measurement(s), e.g. interval #1, and the BS may configure UE 101B with two measurement windows, e.g. window #1 and window #2, and there may be a time interval between the two windows, e.g. interval #2, which has a length longer than the length of interval #1.

In some other embodiments, the indicated time interval may be for TRP measurement(s), and the BS may configure the UE with at least two measurement windows (or at least two measurement gaps, or at least two reference signal resources, or the like) with a time interval equal to or longer than the indicated time interval plus an offset duration. The offset duration may be the maximum RTT between the UE and the TRP, or the maximum RTT between the UE and the BS. Alternatively, the offset duration may have a length longer than the maximum RTT between the UE and the TRP, or the maximum RTT between the UE and the BS.

In FIG. 4B, the positioning server may indicate a time interval for TRP measurement(s), e.g. interval #3, and the BS may configure UE 101B with two measurement windows, e.g. window #3 and window #4, and there may be a time interval between the two windows, e.g. interval #4, which has a length longer than the sum of the length of interval #3 plus the length of the offset duration.

### Embodiment 2

The information for the positioning operation may indicate at least two reference time values for the positioning operation. The reference time value may be a reference starting time value for UE measurement(s), a reference end time value for UE measurement(s), a reference starting time value for TRP measurement(s), or a reference end time value for TRP measurement(s).

For each reference time value, the BS may configure a measurement window (or a measurement gap, or a reference signal resource) based on the reference time value, more specifically, the BS may configure a measurement window (or a measurement gap, or a reference signal resource) as follows:
The reference time value is a reference starting time value for UE measurement(s), and the BS may configure the UE with a measurement window with a starting time equal to or later than the reference starting time value;
The reference time value is a reference end time value for UE measurement(s), and the BS may configure the UE with a measurement window with an end time value equal to or earlier than the reference end time value;
The reference time value is a reference starting time value for TRP measurement(s), and the BS may configure the UE with a measurement window with a starting time equal to or later than the reference starting time value plus an offset duration;
The reference time value is a reference end time value for TRP measurement(s), and the BS may configure the UE with a measurement window with an end time value equal to or earlier than the reference end time value minus an offset duration.

The offset duration may be the maximum RTT between the UE and the TRP; or the maximum RTT between the UE and the BS. Alternatively, the offset duration may have a length longer than the maximum RTT between the UE and the TRP, or the maximum RTT between the UE and the BS.

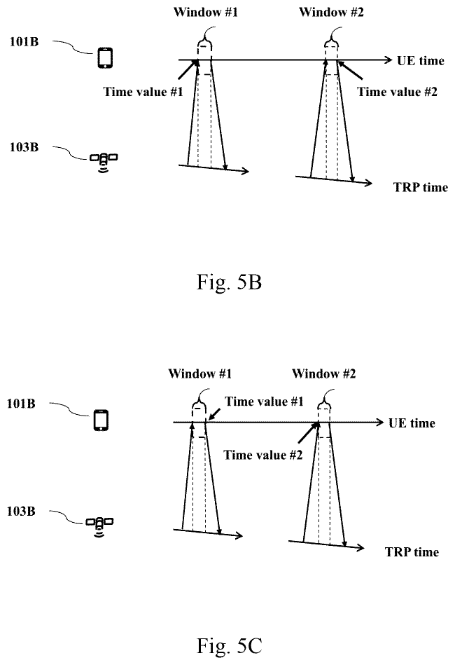

FIGS. 5A-5D illustrate two measurement windows for a positioning operation configured based on the indicated reference time values for UE measurement(s) according to some embodiments of the present disclosure.

In FIGS. 5A-5D, two reference time values for UE measurement(s) are indicated, e.g. time value #1 and time value #2. Based on the two reference time values, two measurement windows are configured, e.g. window #1 and window #2 respectively.

More specifically, in FIG. 5A, time value #1 indicates a starting time value for UE measurement(s), and time value #2 also indicates a starting time value for UE measurement(s), thus the starting time value of window #1 is later than time value #1, and the starting time value of window #2 is later than time value #2.

In FIG. 5B, time value #1 indicates a starting time value for UE measurement(s), and time value #2 indicates an end time value for UE measurement(s), thus the starting time value of window #1 is later than time value #1, and the end time value of window #2 is earlier than time value #2.

In FIG. 5C, time value #1 indicates an end time value for UE measurement(s), and time value #2 indicates a starting time value for UE measurement(s), thus the end time value of window #1 is earlier than time value #1, and the starting time value of window #2 is later than time value #2.

In FIG. 5D, time value #1 indicates an end time value for UE measurement(s), and time value #2 also indicates an end time value for UE measurement(s), thus the end time value of window #1 is earlier than time value #1, and the end time value of window #2 is also earlier than time value #2.

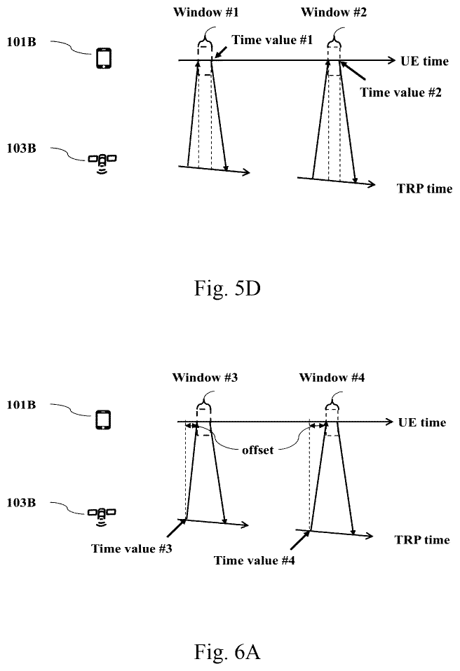

FIGS. 6A-6D illustrate two measurement windows for a positioning operation configured based on the indicated reference time values for TRP measurement(s) according to some embodiments of the present disclosure.

In FIGS. 6A-6D, two reference time values for TRP measurement(s) are indicated, e.g. time value #3 and time value #4. Based on the two reference time values, two measurement windows are configured, e.g. window #3 and window #4 respectively.

More specifically, in FIG. 6A, time value #3 indicates a starting time value for TRP measurement(s), and time value #4 also indicates a starting time value for TRP measurement(s), thus the starting time value of window #3 is later than time value #3 plus an offset duration, and the starting time value of window #4 is later than time value #4 plus the offset duration. The offset duration may be a half of the maximum RTT between UE and TRP associated with the BS, or a half of the maximum RTT between UE and BS. Alternatively, the offset duration may have a length longer than the half of the maximum RTT between the UE and the TRP, or the half of the maximum RTT between the UE and the BS. In some other cases, the offset duration applied to time value #3 and the offset duration applied to time value #4 may be different.

In FIG. 6B, time value #3 indicates a starting time value for TRP measurement(s), and time value #4 indicates an end time value for TRP measurement(s), thus the starting time value of window #3 is later than time value #3 plus the offset duration, and the end time value of window #4 is earlier than time value #4 minus the offset duration.

In FIG. 6C, time value #3 indicates an end time value for TRP measurement(s), and time value #4 indicates a starting time value for TRP measurement(s), thus the end time value of window #3 is earlier than time value #3 minus the offset duration, and the starting time value of window #4 is later than time value #4 plus the offset duration.

In FIG. 6D, time value #3 indicates an end time value for TRP measurement(s), and time value #4 also indicates an end time value for TRP measurement(s), thus the end time value of window #3 is earlier than time value #3 minus the offset duration, and the end time value of window #4 is also earlier than time value #4 minus the offset duration.

### Embodiment 3

The information for the positioning operation may indicate one or more requirements for the positioning operation. For example, the one or more requirements may include one or more accuracy requirements, such as the error range of the position may be within 10 m, 100 m, etc., or the accuracy rate of the UE position may be higher than 90%, 95%, etc.

The BS may determine at least one time interval between at least two positioning measurements based on the one or more requirements, and may configure the UE with at least two measurement windows (or at least two measurement gaps, or at least two reference signal resources, or the like) with a time interval equal to or longer than the at least one determined time interval.

To sum up, based on solution 1, the BS that manages the serving TRP (e.g. a satellite, a RAN node, or antenna units, or the like) of the UE, which may schedule the UE to perform the positioning operation, may be aware of information regarding the time interval, thus the BS may appropriately configure at least two positioning measurement gaps (at least two measuring windows, or at least two reference signal resources) for positioning signals transmission and reception.

In solution 1, the positioning server may determine the information for the positioning operation without the assistance information from the UE or from the BS. In solution 2, the UE and the BS may provide the assistance information to the positioning server, which may indicate available time information for the positioning operation, or indicate the ephemeris information of the TRP, or both. The detailed solutions are presented as follows:

### Solution 2

The assistance information may indicate available time information for the positioning operation. More specifically speaking, the available time information for the positioning operation may include: 1) the remaining available time duration of a cell or a TRP, 2) the remaining available time duration of the ephemeris data at UE side; or 3) the remaining available time duration of the GNSS position at UE side. After receiving the available time information for the positioning operation, the positioning server may determine whether to initiate a positioning operation based on the provided available time information for the positioning operation.

### Embodiment 2-1

Regarding the remaining available time duration of a cell or a TRP, the BS may indicate at least one the following to the positioning server:
a feeder link switch time value of the cell or the TRP;
a common stop serving time value of a quasi-earth-fixed cell or the TRP;
a reference stop serving time value of an earth-moving cell or the TRP; or
a UE-specific stop serving time of an earth-moving cell or the TRP obtained from the UE.

In some cases, the indicated cell or the indicated TRP is the serving cell or the serving TRP of the UE. In some other cases, the indicated cell or the indicated TRP may not be the current serving cell or serving TRP for the UE, the BS may indicate UE to continue the positioning operation before losing connection to the indicated cell or the indicated TRP.

### Embodiment 2-2

Regarding the remaining available time duration of a cell or a TRP, the UE may indicate the following to the positioning server:
a feeder link switch time value of the cell or the TRP, which may be obtained from a serving BS;
a common stop serving time value of a quasi-earth-fixed cell or the TRP, which may be obtained from a serving BS;
a reference stop serving time value of an earth-moving cell or the TRP, which may be obtained from a serving BS;
a UE-specific stop serving time of a cell (e.g. an earth-moving cell) or the TRP, which may be derived by UE.

In some cases, the indicated cell or the indicated TRP may be the serving cell or the serving TRP of the UE. In some other cases, the indicated cell or the indicated TRP may not be the current serving cell or serving TRP for the UE, the UE may be indicated by the BS, to continue the positioning operation before losing connection to the indicated cell or the indicated TRP.

### Embodiment 2-3

Regarding the remaining validity duration of ephemeris information of the TRP at UE side, the UE may indicate it to the positioning server. In some other cases, the UE may indicate the remaining validity duration of ephemeris information of the TRP at UE side to the BS, the BS then indicate it to the positioning server.

Based on the remaining validity duration of ephemeris information, the positioning server may determine whether to initiate a positioning operation. In some embodiments, the positioning server may indicate the UE to re-acquire the ephemeris information of the TRP or not. When it is determined that the UE may need to re-acquire the ephemeris information of the TRP, for example, when the remaining validity duration of ephemeris information at the UE is not long enough for the positioning operation, the positioning server may indicate the BS to trigger the UE to re-acquiring the ephemeris information of the TRP.

Alternatively, the positioning server may not indicate the UE to re-acquire ephemeris information of the TRP, and the BS may determine the configuration for the positioning operation and transmit it to the UE.

After receiving the configuration for the positioning operation from the BS, which may indicate at least two measurement windows (or at least two measurement gaps, or at least two reference signal resources, or the like), the UE may determine the timing relation of remaining validity duration of ephemeris information of the TRP at UE side and the time information of the at least two measurement windows (or at least two measurement gaps, or at least two reference signal resources, or the like).

In some embodiments, the timing relation may include:
Whether an end of the remaining validity duration of ephemeris information of the TRP is equal to or later than the last measurement window (or the last measurement gap, or the last reference signal resource) configured for a positioning operation. In the case that end of the remaining validity duration of ephemeris information of the TRP is equal to or later than the last measurement window, the UE may not re-acquire ephemeris information of the TRP before the positioning operation, otherwise, the UE may determine to re-acquire ephemeris information of the TRP before the positioning operation.
Whether the end of the remaining validity duration of the GNSS position is equal to or later than a measurement window (or a measurement gap, or a reference signal resource) for the positioning operation. In the case that end of the remaining validity duration of ephemeris information of the TRP is equal to or later than a measurement window, the UE may re-acquire ephemeris information of the TRP after the measurement window instead of re-acquiring ephemeris information of the TRP before the positioning operation, otherwise, the UE may determine to re-acquire ephemeris information of the TRP before the measurement window.
Whether a time interval between two measurement windows (or two measurement gaps, or two reference signal resources) for the positioning operation is equal to or longer than a time duration for re-acquiring the ephemeris information of the TRP. In the case that the time interval between two measurement windows for the positioning operation is equal to or longer than a time duration for re-acquiring the ephemeris information of the TRP, the UE may re-acquire ephemeris information of the TRP during the time interval, otherwise, the UE may determine to re-acquire ephemeris information of the TRP before the first measurement window.

In some embodiments, the positioning server may determine the timing relation of remaining validity duration of ephemeris information of the TRP at UE side and the time information of the at least two measurement windows similarly as the UE, and may determine whether to trigger the UE to re-acquire the ephemeris information of the TRP.

### Embodiment 2-4

Regarding the remaining validity duration of GNSS position at UE side, the UE may indicate it to the positioning server. In some other cases, the UE may indicate the remaining validity duration of GNSS position at UE side to the BS, the BS then indicate it to the positioning server.

Based on the remaining duration of GNSS position, the positioning server may determine whether to initiate a positioning operation; or the positioning server may indicate the UE to re-acquire GNSS position or not. When it is determined that the UE may need to re-acquire GNSS position, the positioning server may indicate the BS to trigger the re-acquiring for UE.

Regarding the remaining validity duration of GNSS position at UE side, the UE may indicate it to the positioning server. Based on the remaining validity duration of GNSS position, the positioning server may determine whether to initiate a positioning operation. In some embodiments, the positioning server may indicate the UE to re-acquire the GNSS position or not. When it is determined that the UE may need to re-acquire the GNSS position, for example, when the remaining validity duration of GNSS position at the UE is not long enough for the positioning operation, the positioning server may indicate the BS to trigger the UE to re-acquiring the GNSS position.

Alternatively, the positioning server may not indicate the UE to re-acquire GNSS position, and the BS may determine the configuration for the positioning operation and transmit it to the UE.

After receiving the configuration for the positioning operation from the BS, which may indicate at least two measurement windows (or at least two measurement gaps, or at least two reference signal resources, or the like), the UE may determine the timing relation of remaining validity duration of GNSS position at UE side and the time information of the at least two measurement windows (or at least two measurement gaps, or at least two reference signal resources, or the like).

In some embodiments, the timing relation may include:
Whether an end of the remaining validity duration of GNSS position is equal to or later than the last measurement window (or the last measurement gap, or the last reference signal resource) configured for a positioning operation. In the case that end of the remaining validity duration of GNSS position is equal to or later than the last measurement window, the UE may not re-acquire GNSS position before the positioning operation, otherwise, the UE may determine to re-acquire GNSS position before the positioning operation.
Whether the end of the remaining validity duration of the GNSS position is equal to or later than a measurement window (or a measurement gap, or a reference signal resource) for the positioning operation. In the case that end of the remaining validity duration of GNSS position is equal to or later than a measurement window, the UE may re-acquire GNSS position after the measurement window instead of re-acquiring GNSS position before the positioning operation, otherwise, the UE may determine to re-acquire GNSS position before the measurement window.
Whether a time interval between two measurement windows (or two measurement gaps, or two reference signal resources) for the positioning operation is equal to or longer than a time duration for re-acquiring the GNSS position. In the case that the time interval between two measurement windows for the positioning operation is equal to or longer than a time duration for re-acquiring the GNSS position, the UE may re-acquire GNSS position during the time interval, otherwise, the UE may determine to re-acquire GNSS position before the first measurement window.

In some embodiments, the positioning server may determine the timing relation of remaining validity duration of GNSS position at UE side and the time information of the at least two measurement windows similarly as the UE, and may determine whether to trigger the UE to re-acquire the GNSS position.

In some other embodiments, the assistance information from the BS, from the UE, or both, may indicate ephemeris information of the TRP to the positioning server. Based on the ephemeris information of the TRP, the positioning server may determine the location of the TRP used for positioning measurement at a given time.

The ephemeris information of the TRP includes at least one of: 1) an epoch time value of the ephemeris information; 2) a validity duration of the ephemeris information; 3) an identifier of the ephemeris information; or 4) a format of the ephemeris information.

The epoch time of the ephemeris may be carried by a new information element (IE), which may be referred to as: Ephemeris Epoch Time; may be a part of the new IE, which may be referred to as: Ephemeris Information; or may be carried by an existing IE, which may be referred to as: Time Stamp along with ephemeris.

The validity duration of the ephemeris may be carried by the new IE, e.g. Ephemeris Validity Duration; or may be a part of a new IE, e.g. Ephemeris Information.

The satellite ID of the ephemeris may be carried by the new IE, e.g. Ephemeris Validity Duration; may be a part of a new IE, e.g. Ephemeris Information, or may be carried by the existing IE TRP ID with extension of value range e.g., to 218 values.

The format of the ephemeris may include the following two formats: 1) the orbital parameter ephemeris format; and 2) the position and velocity state vector ephemeris format. In the case the format of the ephemeris is the orbital parameter ephemeris format, the ephemeris information of the TRP may include the orbital parameters, which may include semiMajorAxis, eccentricity, periapsis, longitude, inclination and meanAnomaly, may be carried by a new IE, e.g. Ephemeris Orbital Parameters; or may be a part of a new IE, e.g. Ephemeris Information.

In the case the format of the ephemeris is the position and velocity state vector ephemeris format, the ephemeris information of the TRP may include the position and velocity state vectors, which may include position, position, positionZ, velocity VX, velocity VY and velocity VZ, may be carried by: a new IE, e.g. Ephemeris Location and Velocity, or may be a part of a new IE, e.g. Ephemeris Information; or may be carried by the existing IE, e.g. NG-RAN Access Point Position with extension of value range e.g., altitude to 225 values.

The ephemeris information of the TRP may be placed in at least one of the following IEs: a new IE, e.g. Ephemeris Information; the existing IE, e.g. TRP Information; the existing, e.g. Geographical Coordinates; or the existing, e.g. NG-RAN Access Point Position.

In some embodiment, an IE e.g. Ephemeris Information, may be specified in a protocol, such as the interface protocol between BS and positioning server (e.g., NRPPa), which including at least one of:

The epoch time of an ephemeris data may have a format as follows:

| IE/Group Name | Presence | IE Type and Reference |
|---|---|---|
| SFN | M | INTEGER (0 . . . 1023) |
| Subframe | M | INTEGER (0 . . . 9) |

The validity duration of an ephemeris data may be with a format as follows:

| IE/Group Name | Presence | IE Type and Reference |
|---|---|---|
| Validity | M | ENUMERATED{s5, s10, s15, s20, s25, |
| duration | | s30, s35, s40, s45, s50, s55, s60, |
| | | s120, s180, s240, s900} |

The satellite ID associated to an ephemeris data may be with a format as follows:

| IE/Group Name | Presence | IE Type and Reference |
|---|---|---|
| Satellite/TRP | M | INTEGER (0 . . . 2¹⁸ − 1) |
| Identifier | | |

The IE Ephemeris Information may be associated with at least one ephemeris data may be with the orbital parameter ephemeris format as follows:

| IE/Group Name | Presence | IE Type and Reference |
|---|---|---|
| semiMajorAxis | M | INTEGER (0 . . . 2³³ − 1) |
| eccentricity | M | INTEGER (0 . . . 2²⁰ − 1) |
| periapsis | M | INTEGER (0 . . . 2²⁸ − 1) |
| longitude | M | INTEGER (0 . . . 2²⁸ − 1) |
| inclination | M | INTEGER (−2²⁶ . . . 2²⁶ − 1) |
| meanAnomaly | M | INTEGER (0 . . . 2²⁸ − 1) |

Alternatively, the IE Ephemeris Information may be associated with at least one ephemeris data with the position and velocity state vector ephemeris format as follows:

| IE/Group Name | Presence | IE Type and Reference |
|---|---|---|
| positionX | M | INTEGER (−2²⁵ . . . 2²⁵ − 1) |
| positionY | M | INTEGER (−2²⁵ . . . 2²⁵ − 1) |
| positionZ | M | INTEGER (−2²⁵ . . . 2²⁵ − 1) |
| velocityVX | M | INTEGER (−2¹⁷ . . . 2¹⁷ − 1) |
| velocityVY | M | INTEGER (−2¹⁷ . . . 2¹⁷ − 1) |
| velocityVZ | M | INTEGER (−2¹⁷ . . . 2¹⁷ − 1) |

It should be noted the above IEs are exemplary, and other IEs that can achieve the same function may also be applied in the present disclosure.

The above information from the UE (which may include at least one of the following: the remaining available time duration of a cell or a TRP; the remaining validity duration of ephemeris information of the TRP at UE side; or the remaining validity duration of GNSS position at UE side) may be transmitted to the BS, for example, with the LTE positioning protocol (LPP), and the BS may forward the information to the positioning server. Alternatively, the above information from the UE may be transmitted to the BS in an air interface protocol, e.g. NR or LTE, and the BS may transmit the information from the UE to the positioning server with NR positioning protocol A (NRPPa) protocol.

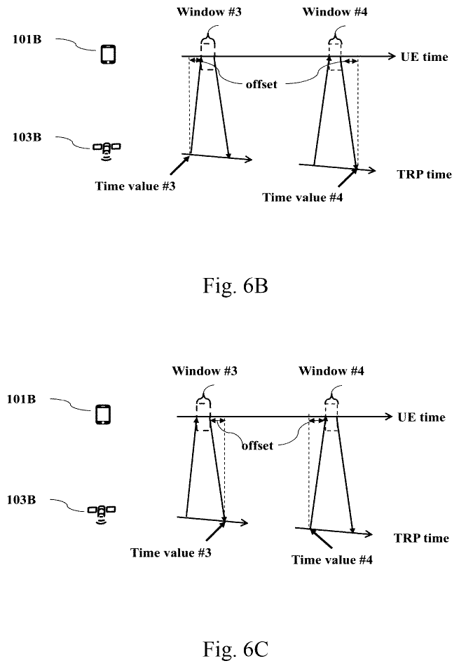

FIG. 7 illustrates a method performed by a UE for a positioning operation according to some embodiments of the present disclosure.

In operation 701, the UE may transmit, via the transceiver, to a positioning server, assistance information for a positioning operation before an end of the positioning operation, wherein the assistance information includes at least one of available time information for the positioning operation or ephemeris information of a TRP. In operation 702, the UE may receive, via the transceiver, from a BS, a configuration for the positioning operation.

In some embodiments, the available time information for the positioning operation includes at least one of the following: a feeder link switch time value of a cell or the TRP obtained from the BS; a stop serving time value of the cell or the TRP obtained from the BS; a UE-specific stop serving time value of the cell or the TRP determined by the UE; a remaining validity duration of ephemeris information of the TRP determined by the UE; or a remaining validity duration of a GNSS position determined by the UE. In some cases, the cell or the TRP may not be the serving cell or serving TRP of the UE.

In some embodiments, the ephemeris information of the TRP includes at least one of the following: an epoch time value of the ephemeris information; a validity duration of the ephemeris information; an identifier of the ephemeris information (e.g. an ID of a satellite); or a format of the ephemeris information (e.g. the orbital parameter ephemeris format; or the position and velocity state vector ephemeris format).

In some embodiments, the configuration for the positioning operation indicates at least two measurement windows or at least two reference signal resources, wherein a time interval is included between two measurement windows of the at least two measurement windows or two reference signal resources of the at least two reference signal resources; or wherein a measurement window of the at least two measurement windows or a reference signal resource of the at least two reference signal resources is associated with at least one of a starting time value or an end time value.

In some embodiments, the UE may re-acquire ephemeris information in response to one of the following:
an end of a remaining validity duration of the ephemeris information of a serving cell of the UE being earlier than a last measurement window or a last reference signal resource for the positioning operation. That is, the remaining validity duration of the ephemeris information may not cover the duration of the entire positioning operation.
the end of the remaining validity duration of the ephemeris information of the serving cell of the UE being earlier than a measurement window or a reference signal resource for the positioning operation. That is, the remaining validity duration of the ephemeris information may expire during a measurement window for the positioning operation, for example, as shown in FIG. 3, the ephemeris information expires during window #3.
a time interval between two measurement windows or two reference signal resources for the positioning operation being equal to or longer than a time duration for re-acquiring the ephemeris information. For example, in FIG. 3, the interval between window #3 and window #4 may be equal to or longer than a time duration for re-acquiring the ephemeris information.

In some embodiments, the UE may re-acquire a GNSS position in response to one of the following:
an end of a remaining validity duration of the GNSS position being earlier than a last measurement window or a last reference signal resource for the positioning operation. That is, the remaining validity duration of the GNSS position may not cover the duration of the entire positioning operation.
the end of the remaining validity duration of the GNSS position being earlier than a measurement window or a reference signal resource for the positioning operation. That is, the remaining validity duration of the GNSS position may expire during a measurement window for the positioning operation, for example, as shown in FIG. 3, the GNSS position expires during window #4.
a time interval between two measurement windows or two reference signal resources for the positioning operation being equal to or longer than a time duration for re-acquiring the GNSS position. For example, in FIG. 3, the interval between window #3 and window #4 may be equal to or longer than a time duration for re-acquiring the GNSS position.

In some embodiments the two measurement windows are two neighboring measurement windows, any two measurement windows, or two specific measurement windows; and wherein the two reference signal resources are two neighboring reference signal resources in the time domain, any two reference signal resources, or two specific reference signal resources.

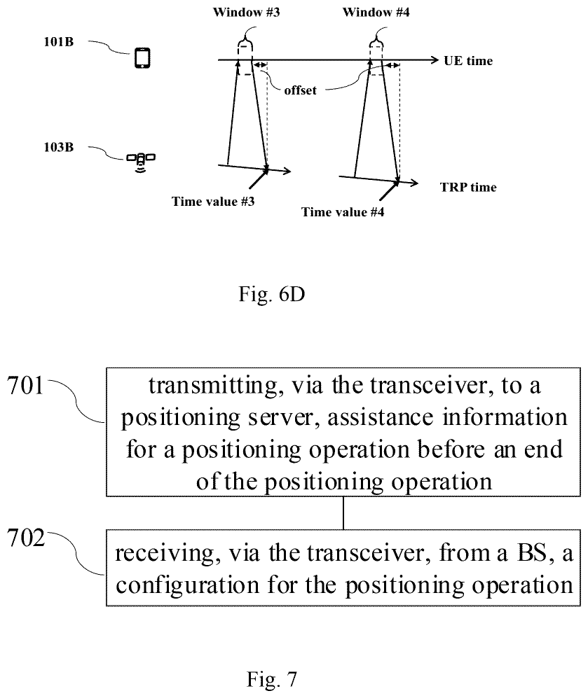

FIG. 8 illustrates a method performed by a BS for a positioning operation according to some embodiments of the present disclosure.

In operation 801, the BS may transmit, via the transceiver, to a positioning server, assistance information for a positioning operation before an end of the positioning operation, wherein the assistance information includes at least one of available time information for the positioning operation or ephemeris information of a TRP. In operation 802, the BS may receive, via the transceiver, from the positioning server, first information for the positioning operation.

In some embodiments, the BS may transmit, via the transceiver, to a UE, a configuration for the positioning operation based on the first information for the positioning operation.

In some embodiments, the first information for the positioning operation indicates one of the following: a first time interval for UE positioning measurement (e.g. interval #1 as shown in FIG. 4A); or a second time interval for TRP positioning measurement (e.g. interval #3 as shown in FIG. 4B).

In some embodiments, the configuration for the positioning operation indicates at least two measurement windows or at least two reference signal resources,
in the case that the first time interval for UE positioning measurement is indicated, a time interval with a length equal to or longer than a length of the first time interval is included between two measurement windows of the at least two measurement windows or two reference signal resources of the at least two reference signal resources. For example, as shown in FIG. 4A, interval #2 is included between measurement window #1 and measurement window #2, and with a length longer than the length of interval #1.
in the case that the second time interval for TRP positioning measurement is indicated, a time interval with a length equal to or longer than a sum of a length of the second time interval plus a maximum RTT value is included between two measurement windows of the at least two measurement windows, or between two reference signal resources of the at least two reference signal resources, wherein the RTT value is a round trip time value between the UE and the TRP associated with the BS, or between the UE and the BS. For example, as shown in FIG. 4b, interval #4 is included between measurement window #3 and measurement window #4, and with a length longer than the sum of the length of interval #3 plus the maximum RTT value.

In some embodiments, the two measurement windows are two neighboring measurement windows, any two measurement windows, or two specific measurement windows; and wherein the two reference signal resources are two neighboring reference signal resources in the time domain, any two reference signal resources, or two specific reference signal resources.

In some embodiments, the first information for the positioning operation indicates at least two reference time values, and
in the case a reference time value of the at least two reference time values is a starting time value for UE measurement(s), the configuration indicates a measurement window or a reference signal resource with a starting time value later than or equal to the reference time value. For example, as shown in FIG. 5B, time value #1 is a starting time value for UE measurement(s), and window #1 is with a starting time value later than time value #1.
in the case a reference time value of the at least two reference time values is an end time value for UE measurement(s), the configuration indicates a measurement window or a reference signal resource with an end time value earlier than or equal to the reference time value. For example, as shown in FIG. 5B, time value #2 is a starting time value for UE measurement(s), and window #2 is with an end time value earlier than time value #2.
in the case a reference time value of the at least two reference time values is a starting time value for TRP measurement(s), the configuration indicates a measurement window or a reference signal resource with a starting time value later than or equal to the reference time value plus a half of an RTT value. For example, as shown in FIG. 6B, time value #3 is a starting time value for TRP measurement(s), and window #3 is with a starting time value later than time value #3 plus a half of an RTT value.
in the case a reference time value of the at least two reference time values is an end time value for TRP measurement(s), the configuration indicates a measurement window or a reference signal resource with an end time value earlier than or equal to the reference time value minus the half of the RTT value. For example, as shown in FIG. 6B, time value #4 is an end time value for TRP measurement(s), and window #4 is with a starting time value earlier than time value #4 minus the half of an RTT value.

In some embodiments, the abovementioned RTT value is a round trip time value between the UE and the TRP associated with the BS, or between the UE and the BS.

In some embodiments, the first information for the positioning operation indicates an accuracy requirement for the positioning operation.

In some embodiments, the available time information for the positioning operation includes at least one of the following: a feeder link switch time value of a cell or a TRP; a stop serving time value of the cell or the TRP; a UE-specific stop serving time value of the cell or the TRP obtained from the UE; a remaining validity duration of ephemeris information of the TRP obtained from the UE; or a remaining validity duration of a GNSS position obtained from the UE.

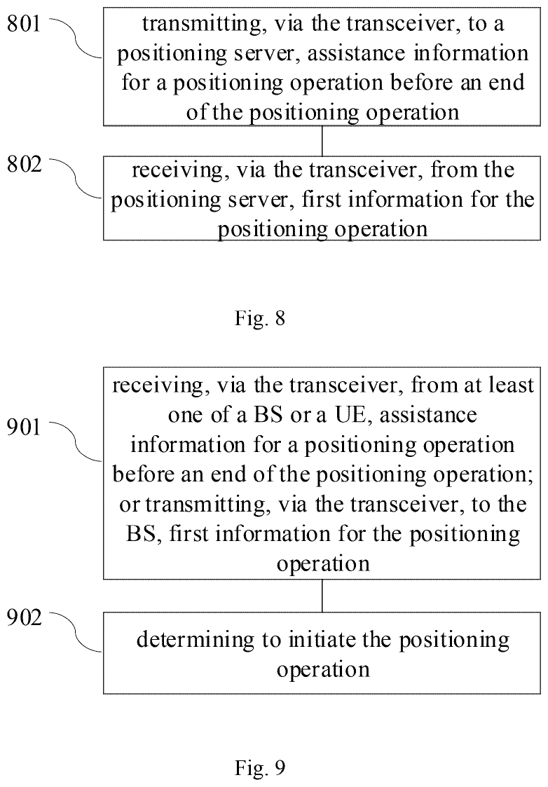

FIG. 9 illustrates a method performed by a positioning server for a positioning operation according to some embodiments of the present disclosure.

In operation 901, the positioning server may receive, via the transceiver, from at least one of a BS or a UE, assistance information for a positioning operation before an end of the positioning operation; or transmit, via the transceiver, to the BS, first information for the positioning operation. In operation 902, the positioning server may determine to initiate the positioning operation, wherein the assistance information includes at least one of available time information for the positioning operation or ephemeris information of a TRP.

In some embodiments, the positioning server may determine to initiate the positioning operation based on the assistance information.

In some embodiments, the positioning server may determine a position of the TRP at a specific time value based on the ephemeris information of the TRP.

In some embodiments, the positioning server may determine the first information based on the assistance information.

In some embodiments, the first information for the positioning operation indicates one of the following: a first time interval for UE positioning measurement; or a second time interval for TRP positioning measurement; at least two reference time values, wherein a reference time value of the at least two reference time values indicates one of the following: a starting time value for UE measurement(s), an end time value for UE measurement(s), a starting time value for TRP measurement(s), or an end time value for TRP measurement(s); or an accuracy requirement for the positioning operation.

In some embodiments, the positioning server may indicate the UE to re-acquire the ephemeris information of the TRP or the GNSS position based on the assistance information before the end of the positioning operation.

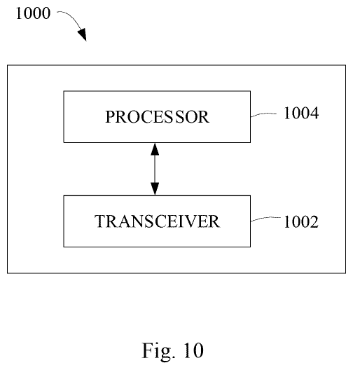

FIG. 10 illustrates a simplified block diagram of an apparatus according to some embodiments of the present disclosure.

As shown in FIG. 10, an example of the apparatus 1000 may include at least one processor 1004 and at least one transceiver 1002 coupled to the processor 1004. The apparatus 1000 may be a UE, a BS, a RAN node, a TRP, a positioning server, or any other device with similar functions.

Although in this figure, elements such as the at least one transceiver 1002 and processor 1004 are described in the singular, the plural is contemplated unless a limitation to the singular is explicitly stated. In some embodiments of the present disclosure, the transceiver 1002 may be divided into two devices, such as a receiving circuitry and a transmitting circuitry. In some embodiments of the present disclosure, the apparatus 1000 may further include an input device, a memory, and/or other components.

In some embodiments of the present disclosure, the apparatus 1000 may be a UE. The transceiver 1002 and the processor 1004 may interact with each other so as to perform the operations of the UE described in any of FIGS. 1A-9. In some embodiments of the present disclosure, the apparatus 1000 may be a BS. The transceiver 1002 and the processor 1004 may interact with each other so as to perform the operations of the BS described in any of FIGS. 1A-9. In some embodiments of the present disclosure, the apparatus 1000 may be a positioning server. The transceiver 1002 and the processor 1004 may interact with each other so as to perform the operations of the positioning server described in any of FIGS. 1A-9.

In some embodiments of the present disclosure, the apparatus 1000 may further include at least one non-transitory computer-readable medium.

For example, in some embodiments of the present disclosure, the non-transitory computer-readable medium may have stored thereon computer-executable instructions to cause the processor 1004 to implement the method with respect to the UE as described above. For example, the computer-executable instructions, when executed, cause the processor 1004 interacting with transceiver 1002 to perform the operations of the UE described in any of FIGS. 1A-9.

In some embodiments of the present disclosure, the non-transitory computer-readable medium may have stored thereon computer-executable instructions to cause the processor 1004 to implement the method with respect to the BS or the positioning server as described above. For example, the computer-executable instructions, when executed, cause the processor 1004 interacting with transceiver 1002 to perform the operations of the BS or the positioning server described in any of FIGS. 1A-9.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each FIG. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
transmit, to a positioning server, assistance information for a positioning operation before an end of the positioning operation, wherein the assistance information includes at least one of available time information for the positioning operation or ephemeris information of a transmission and reception point (TRP); and
receive, from a base station (BS), a configuration for the positioning operation.

2. The UE of claim 1, wherein the available time information for the positioning operation includes at least one of the following:
a feeder link switch time value of a cell or the TRP obtained from the BS;
a stop serving time value of the cell or the TRP obtained from the BS;
a UE-specific stop serving time value of the cell or the TRP determined by the UE;
a remaining validity duration of ephemeris information of the TRP determined by the UE;
or
a remaining validity duration of a global navigation satellite system (GNSS) position determined by the UE.

3. The UE of claim 1, wherein the ephemeris information of the TRP includes at least one of the following:
an epoch time value of the ephemeris information;
a validity duration of the ephemeris information;
an identifier of the ephemeris information; or
a format of the ephemeris information.

4. The UE of claim 1, wherein the at least one processor is further configured to cause the UE to re-acquire ephemeris information in response to one of the following:
an end of a remaining validity duration of the ephemeris information of a serving cell of the UE being earlier than a last measurement window or a last reference signal resource for the positioning operation;
the end of the remaining validity duration of the ephemeris information of the serving cell of the UE being earlier than a measurement window or a reference signal resource for the positioning operation; or
a time interval between two measurement windows or two reference signal resources for the positioning operation being equal to or longer than a time duration for re-acquiring the ephemeris information.

5. The UE of claim 1, wherein the at least one processor is further configured to cause the UE to re-acquire a global navigation satellite system (GNSS) position in response to one of the following:
an end of a remaining validity duration of the GNSS position being earlier than a last measurement window or a last reference signal resource for the positioning operation;
the end of the remaining validity duration of the GNSS position being earlier than a measurement window or a reference signal resource for the positioning operation; or
a time interval between two measurement windows or two reference signal resources for the positioning operation being equal to or longer than a time duration for re-acquiring the GNSS position.

6. A base station (BS) for wireless communication, comprising:
at least one memory; and
at least one processor coupled with the at least one memory and configured to cause the BS to:
transmit, to a positioning server, assistance information for a positioning operation before an end of the positioning operation, wherein the assistance information includes at least one of available time information for the positioning operation or ephemeris information of a transmission and reception point (TRP); and
receive, from the positioning server, first information for the positioning operation.

7. The BS of claim 6, wherein the first information for the positioning operation indicates one of the following:
a first time interval for UE positioning measurement; or
a second time interval for TRP positioning measurement.

8. The BS of claim 7, wherein the configuration for the positioning operation indicates at least two measurement windows or at least two reference signal resources; wherein,
when the first time interval for UE positioning measurement is indicated, a time interval with a length equal to or longer than a length of the first time interval is included between two measurement windows of the at least two measurement windows or two reference signal resources of the at least two reference signal resources; or
when the second time interval for TRP positioning measurement is indicated, a time interval with a length equal to or longer than a sum of a length of the second time interval plus a maximum round trip time (RTT) value is included between two measurement windows of the at least two measurement windows, or between two reference signal resources of the at least two reference signal resources, wherein the RTT value is a round trip time value between the UE and the TRP associated with the BS, or between the UE and the BS; and
wherein the two measurement windows are two neighboring measurement windows, any two measurement windows, or two specific measurement windows; and wherein the two reference signal resources are two neighboring reference signal resources in the time domain, any two reference signal resources, or two specific reference signal resources.

9. The BS of claim 6, wherein the available time information for the positioning operation includes at least one of the following:
a feeder link switch time value of a cell or a TRP;
a stop serving time value of the cell or the TRP;
a UE-specific stop serving time value of the cell or the TRP obtained from the UE;
a remaining validity duration of ephemeris information of the TRP obtained from the UE;
or
a remaining validity duration of a global navigation satellite system (GNSS) position obtained from the UE.

10. The BS of claim 6, wherein the ephemeris information of the TRP includes at least one of the following:
an epoch time value of the ephemeris information;
a validity duration of the ephemeris information;
an identifier of the ephemeris information; or
a format of the ephemeris information.

11. A positioning server for wireless communication, comprising:
at least one memory; and
at least one processor coupled with the at least one memory and configured to cause the positioning server to:
receive, from at least one of a base station (BS) or a user equipment (UE), assistance information for a positioning operation before an end of the positioning operation; or
transmit, to the BS, first information for the positioning operation; and
determine to initiate the positioning operation,
wherein the assistance information includes at least one of available time information for the positioning operation or ephemeris information of a transmission and reception point (TRP).

12. The positioning server of claim 11, wherein the available time information for the positioning operation from the UE includes at least one of the following:
a feeder link switch time value of a serving cell or the TRP obtained from the BS;
a stop serving time value of the serving cell or the TRP obtained from the BS;
a UE-specific stop serving time value of the serving cell or the TRP determined by the UE;
a remaining validity duration of ephemeris information of the TRP determined by the UE;
or
a remaining validity duration of a global navigation satellite system (GNSS) position determined by the UE.

13. The positioning server of claim 11, wherein the available time information for the positioning operation from the BS includes at least one of the following:
a feeder link switch time value of a serving cell or a transmission and reception point (TRP);
a stop serving time value of the serving cell or the TRP;
a UE-specific stop serving time value of the serving cell or the TRP obtained from the UE;
a remaining validity duration of ephemeris information of the TRP obtained from the UE;
or
a remaining validity duration of a global navigation satellite system (GNSS) position obtained from the UE.

14. The positioning server of claim 11, wherein the ephemeris information of the TRP includes at least one of the following:
a feeder link switch time value of a serving cell or a transmission and reception point (TRP);
a stop serving time value of the serving cell or the TRP;
an epoch time value of the ephemeris information;
a validity duration of the ephemeris information;
an identifier of the ephemeris information; or
a format of the ephemeris information.

15. The positioning server of claim 11, wherein the first information for the positioning operation indicates one of the following:
a first time interval for UE positioning measurement, or a second time interval for TRP positioning measurement;
at least two reference time values, wherein a reference time value of the at least two reference time values indicates one of the following: a starting time value for UE measurement, an end time value for UE measurement, a starting time value for TRP measurement, or an end time value for TRP measurement; or
an accuracy requirement for the positioning operation.

16. A method performed by a user equipment (UE), the method comprising:
transmitting, to a positioning server, assistance information for a positioning operation before an end of the positioning operation, wherein the assistance information includes at least one of available time information for the positioning operation or ephemeris information of a transmission and reception point (TRP); and
receiving, from a base station (BS), a configuration for the positioning operation.

17. The method of claim 16, wherein the available time information for the positioning operation includes at least one of the following:
a feeder link switch time value of a cell or the TRP obtained from the BS;
a stop serving time value of the cell or the TRP obtained from the BS;
a UE-specific stop serving time value of the cell or the TRP determined by the UE;
a remaining validity duration of ephemeris information of the TRP determined by the UE;
or
a remaining validity duration of a global navigation satellite system (GNSS) position determined by the UE.

18. The method of claim 16, wherein the ephemeris information of the TRP includes at least one of the following:
an epoch time value of the ephemeris information;
a validity duration of the ephemeris information;
an identifier of the ephemeris information; or
a format of the ephemeris information.

19. The method of claim 16, further comprising:
re-acquiring ephemeris information in response to:
an end of a remaining validity duration of the ephemeris information of a serving cell of the UE being earlier than a last measurement window or a last reference signal resource for the positioning operation;
the end of the remaining validity duration of the ephemeris information of the serving cell of the UE being earlier than a measurement window or a reference signal resource for the positioning operation; or
a time interval between two measurement windows or two reference signal resources for the positioning operation being equal to or longer than a time duration for re-acquiring the ephemeris information.

20. The method of claim 16, wherein the at least one processor is further configured to cause the UE to re-acquire a global navigation satellite system (GNSS) position in response to:
an end of a remaining validity duration of the GNSS position being earlier than a last measurement window or a last reference signal resource for the positioning operation;
the end of the remaining validity duration of the GNSS position being earlier than a measurement window or a reference signal resource for the positioning operation; or
a time interval between two measurement windows or two reference signal resources for the positioning operation being equal to or longer than a time duration for re-acquiring the GNSS position.
